(19) United States
(12) Patent Application Publication
(10) Pub. No.: US 2023/0101704 A1
(43) Pub. Date: Mar. 30, 2023

(54) VIDEO GENERATION METHOD AND APPARATUS, ELECTRONIC DEVICE AND READABLE STORAGE MEDIUM

(71) Applicant: BEIJING BAIDU NETCOM SCIENCE TECHNOLOGY CO., LTD., Beijing (CN)

(72) Inventors: Ruifeng DENG, Beijing (CN); Tianwei LIN, Beijing (CN); Fu LI, Beijing (CN)

(73) Assignee: BEIJING BAIDU NETCOM SCIENCE TECHNOLOGY CO., LTD., Beijing (CN)

(21) Appl. No.: 17/898,704

(22) Filed: Aug. 30, 2022

(30) Foreign Application Priority Data
Sep. 29, 2021 (CN) 202111152771.9

(51) Int. Cl. G06V 40/16; G06T 13/40; H04N 21/44

(52) U.S. Cl. CPC G06V 40/168; G06T 13/40; H04N 21/44008

(57) ABSTRACT

The present disclosure discloses a video generation method and apparatus, an electronic device and a readable storage medium, and relates to the field of artificial intelligence, and in particular, to computer vision and deep learning technologies, which may specifically be used in 3D visual scenarios. A specific implementation scheme involves: determining a reference portrait in an original image; performing posture change processing on the reference portrait in the original image by using a nonlinear function, to obtain at least one change image; and generating a dynamic video of the reference portrait according to the original image and the at least one change image.

### CROSS-REFERENCE TO RELATED APPLICATIONS

The present application claims the priority of Chinese Patent Application No. 202111152771.9, filed on Sep. 29, 2021, with the title of “VIDEO GENERATION METHOD AND APPARATUS, ELECTRONIC DEVICE AND READABLE STORAGE MEDIUM.” The disclosure of the above application is incorporated herein by reference in its entirety.

### FIELD OF THE DISCLOSURE

The present disclosure discloses relates to the field of artificial intelligence, and in particular, to computer vision and deep learning technologies, which may specifically be used in 3D visual scenarios.

### BACKGROUND OF THE DISCLOSURE

With the further development of the Internet, applications (APPs) applied to terminals emerge one after another. Video output of virtual portrait images may be involved in some APPs. Generally, a virtual portrait video showing portrait posture changes may be generated according to a reference image of a portrait, for example, virtual assistant self-service APPs in public scenarios such as subways, banks and government affairs.

At present, there is a need to process the reference image of the portrait manually by using image processing software, so as to obtain a plurality of change images with different portrait postures. Then, the reference image of the portrait and the obtained plurality of change images with different portrait postures may be taken as a plurality of video frame images of a portrait video to form a virtual portrait video.

### SUMMARY OF THE DISCLOSURE

The present disclosure provides a video generation method and apparatus, an electronic device and a readable storage medium.

According to one aspect of the present disclosure, a video generation method is provided, including determining a reference portrait in an original image; performing posture change processing on the reference portrait in the original image by using a nonlinear function, to obtain at least one change image; and generating a dynamic video of the reference portrait according to the original image and the at least one change image.

According to another aspect of the present disclosure, an electronic device is provided, including: at least one processor; and a memory communicatively connected with the at least one processor; wherein the memory stores instructions executable by the at least one processor, and the instructions are executed by the at least one processor to enable the at least one processor to perform a video generation method, wherein the video generation method includes determining a reference portrait in an original image; performing posture change processing on the reference portrait in the original image by using a nonlinear function, to obtain at least one change image; and generating a dynamic video of the reference portrait according to the original image and the at least one change image.

According to yet another aspect of the present disclosure, there is provided a non-transitory computer readable storage medium with computer instructions stored thereon, wherein the computer instructions are used for causing a computer to perform a video generation method, wherein the video generation method includes determining a reference portrait in an original image; performing posture change processing on the reference portrait in the original image by using a nonlinear function, to obtain at least one change image; and generating a dynamic video of the reference portrait according to the original image and the at least one change image.

As can be seen from the above technical solutions, in the embodiments of the present disclosure, a reference portrait in an original image is determined, and then posture change processing is performed on the reference portrait in the original image by using a nonlinear function, to obtain at least one change image, so that a dynamic video of the reference portrait can be generated according to the original image and the at least one change image, which does not require manual participation, and is easy to operate and error-free, thereby improving the efficiency and reliability of dynamic video generation.

In addition, user experience can be effectively improved by using the technical solutions according to the present disclosure.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

In order to more clearly illustrate the technical solutions in embodiments of the present disclosure, the accompanying drawings used in the description of the embodiments or the prior art will be briefly introduced below. It is apparent that the accompanying drawings in the following description are only some embodiments of the present disclosure, and other drawings can be obtained by those of ordinary skill in the art from the provided drawings without creative efforts. The drawings are intended to provide a better understanding of the solutions and do not constitute limitations on the present disclosure. In the drawings,

FIG. 1 is a schematic diagram according to a first embodiment of the present disclosure;

FIG. 2 shows an exemplary original image according to the embodiment corresponding to FIG. 1;

FIG. 3 is a schematic diagram of a reference portrait identified from the original image provided in FIG. 2;

FIG. 4 is a schematic diagram of a portrait dilation contour determined from the original image provided in FIG. 2;

FIG. 5 is a schematic diagram of a portrait erosion contour determined from the original image provided in FIG. 2;

FIG. 6 is a schematic diagram of exemplary distribution of triangles into which the original image provided in FIG. 2 is divided;

FIG. 7 is a schematic diagram of exemplary distribution of one type of human body key points the original image provided in FIG. 2 is divided;

FIG. 8 is a schematic diagram according to a second embodiment of the present disclosure; and

FIG. 9 is a block diagram of an electronic device configured to perform a video generation method according to an embodiment of the present disclosure.

### DETAILED DESCRIPTION OF PREFERRED EMBODIMENTS

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

Obviously, the embodiments described are some of rather than all of the embodiments of the present disclosure. All other embodiments acquired by those of ordinary skill in the art without creative efforts based on the embodiments of the present disclosure fall within the protection scope of the present disclosure.

It is to be noted that the terminal device involved in the embodiments of the present disclosure may include, but is not limited to, smart devices such as mobile phones, Personal Digital Assistants (PDAs), wireless handheld devices, and Tablet Computers. The display device may include, but is not limited to, devices with a display function such as personal computers and televisions.

In addition, the term “and/or” herein is merely an association relationship describing associated objects, indicating that three relationships may exist. For example, A and/or B indicates that there are three cases of A alone, A and B together, and B alone. Besides, the character “/” herein generally means that associated objects before and after it are in an “or” relationship.

With the further development of the Internet, APPs applied to terminals emerge one after another. Video output of virtual portrait images may be involved in some APPs. Generally, a virtual portrait video showing portrait posture changes may be generated according to a reference image of a portrait, for example, virtual assistant self-service APPs in public scenarios such as subways, banks and government affairs.

In some application scenarios, a portrait dynamic video capable of showing portrait posture changes is required to be generated based on a reference image including a portrait. Generally, the portrait in the reference image is deformed manually through image processing software (such as Photo Shop (PS)), to obtain a plurality of change images with different portrait postures, and then the reference image and the plurality of change images obtained based on the reference image are further taken as a plurality of video frame images of the portrait dynamic video.

The above manner of generating a portrait dynamic video based on a reference image requires more manual participation, has complicated operations, and is prone to errors, resulting in low efficiency of video generation and poor reliability of the video.

Therefore, in order to solve at least one of the above technical problems in the prior art, it is urgent to provide a more efficient and reliable video generation method.

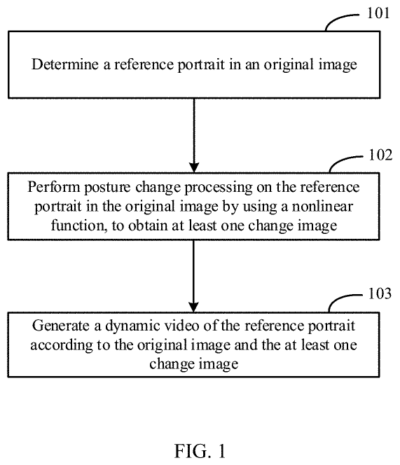

FIG. 1 is a schematic diagram according to a first embodiment of the present disclosure, as shown in FIG. 1.

In 101, a reference portrait in an original image is determined.

In 102, posture change processing is performed on the reference portrait in the original image by using a nonlinear function, to obtain at least one change image.

The nonlinear function used refers to a function whose function image is not a straight line, such as an exponential function, a power function, a logarithmic function, a polynomial function, or a trigonometric function.

A portrait posture in each of the obtained at least one change image is different from that in the original image.

In 103, a dynamic video of the reference portrait is generated according to the original image and the at least one change image.

In the video generation method according to this embodiment, firstly, a reference portrait in an original image is determined, and then a plurality of change images with different postures from the reference portrait in the original image are sequentially generated by using a nonlinear function. After the at least one change image is obtained, the original image and the at least one change image may be taken as a video frame image set, to obtain a dynamic video of the reference portrait in the original image.

It may be understood that, when the dynamic video of the reference portrait is played, the original image and the at least one change image may be sequentially displayed, so as to smoothly display a posture changing process of the reference portrait. The whole process does not require human participation and is easy to operate, which may save costs and improve the efficiency and reliability of video generation.

So far, by using the nonlinear function, the reference portrait in a silent state is driven to produce slight involuntary shaking similar to that of a real character in the silent state, so that a virtual human in the silent state looks more realistic rather than completely frozen in place.

It is to be noted that 101 to 103 may be partially or wholly performed by an APP located at a local terminal, or a functional unit such as a plug-in or Software Development Kit (SDK) provided in an App located at a local terminal, or a processing engine located in a network-side server, or a distributed system on a network side, for example, a processing engine or distributed system in an image processing platform on a network side or the like, which is not particularly limited in this embodiment.

It may be understood that the APP may be a native application (nativeApp) installed in the local terminal, or a web application (webApp) of a browser in the local terminal, which is not particularly limited in this embodiment.

In this way, a reference portrait in an original image is determined, and then posture change processing is performed on the reference portrait in the original image by using a nonlinear function, to obtain at least one change image, so that a dynamic video of the reference portrait can be generated according to the original image and the at least one change image, which does not require manual participation, and is easy to operate and error-free, thereby improving the efficiency and reliability of dynamic video generation.

In this embodiment, each frame image forming the dynamic video is obtained based on change processing of the original image, and the loss of the image quality thereof is minimized, which is basically invisible to naked eyes, so that the generated dynamic video has high resolution.

The technical solution according to this embodiment is a solution purely based on image character posture changes, so that the quality of the video frame image of the dynamic video is maintained at a high level, and it is easy to control a motion trajectory.

At the same time, in the technical solution according to this embodiment, the posture change processing performed based on the nonlinear function is random nonlinear change processing, but not uniform change processing, so as to prevent mechanical and unnatural portrait motion caused by uniform posture change processing.

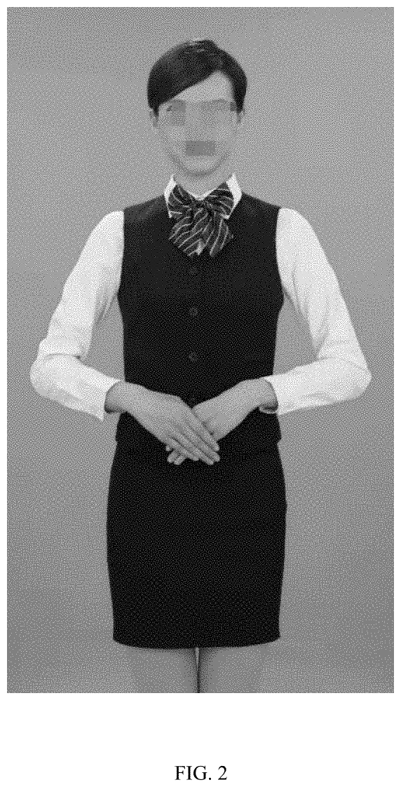

FIG. 2 shows an exemplary original image according to the first embodiment of the present disclosure. In this embodiment, as shown in FIG. 2, the reference portrait in the original image may be a real portrait, or a virtual portrait created using a virtual technology, which is not particularly limited in this embodiment.

It is to be noted that, when the reference portrait in the original image is a real portrait, related authorization is further required, such as the authorization of the real portrait in the original image. Moreover, the method according to this embodiment does not require acquisition of privacy information of the real portrait in the original image, such as iris, lip print or fingerprint.

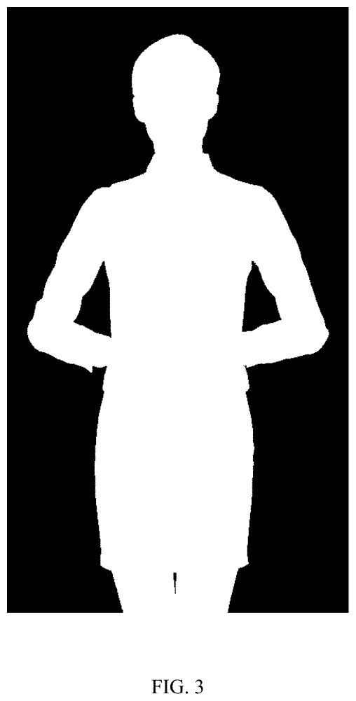

It may be understood that the original image includes background content and the reference portrait. In 101, the reference portrait is required to be identified from the original image. Specifically, an existing portrait segmentation technology may specifically be used to segment the portrait in the original image to identify the reference image. FIG. 3 is a schematic diagram of a reference portrait identified from the original image provided in FIG. 2. In FIG. 3, a black region represents the background content and a white region represents the reference portrait.

The technical solution according to this embodiment may not only be applied to an image to drive a reference portrait in a silent state in the image, but also be further extended to video to drive a reference portrait in a silent state in a multi-frame image in the video, which is more flexible.

Optionally, in one possible implementation of this embodiment, in 101, the original image that applies may be one or more images, which is not particularly limited in this embodiment.

During a specific implementation, an image including the reference portrait may specifically be taken as the original image.

In this case, the reference portrait in the silent state in the image may be driven by using the nonlinear function.

During another specific implementation, a continuous multi-frame image including the reference portrait may be obtained from a video as the original image. The continuous multi-frame image is a continuous frame image captured in the video.

In this case, the reference portrait in the silent state in the multi-frame image in the video may be driven by using the nonlinear function, which is more flexible than the technical solution that can only drive the reference portrait in the silent state in the image.

During the implementation, the technical solution according to this embodiment may be extended to video-level portrait drive. To drive the portrait in the video, posture change processing may be performed on the reference portrait in each frame image of the video by using the nonlinear function, which is equivalent to adding a slight shake to the original motion of the portrait in the video.

With the continuous development of a virtual human technology, the solution of driving the portrait in the silent state should be as extensible as possible. In the technical solution according to this embodiment, motion changes of each frame can be easily superimposed into the original video, which has high scalability.

Optionally, in one possible implementation of this embodiment, in 102, specifically, at least one change parameter of the reference portrait may be obtained by using the nonlinear function, and then posture change processing may be performed on the reference portrait in the original image based on the at least one change parameter, to obtain the at least one change image.

In this way, the change parameter obtained based on the nonlinear function is a random nonlinear change parameter. Therefore, the posture change processing performed based on this is also random nonlinear change processing, but not uniform change processing, so as to prevent mechanical and unnatural portrait motion caused by uniform posture change processing.

During a specific implementation, in order to better control the motion trajectory and make it more natural, a trigonometric function may be taken as the nonlinear function driving the reference portrait. Assuming that n frames of change images are required for posture change transition between a reference posture of the reference portrait and a target posture of the reference portrait, where n is an integer greater than or equal to 1, and a rotation angle required to change the target posture relative to the reference posture is theta, a rotation angle of an i^{th}-frame change image is theta*sin(pi/2*i/n). After rotation to an n^{th}-frame change image with the target posture, the motion of the reference portrait of this round has been completed.

After one round of motion of the reference portrait is completed, a rotation angle of its initial position may be aligned with a previous-frame image by adjusting an initial phase fi of the trigonometric function and bias in the next round of motion, for example, bias+theta′*cos(pi*i/n). Based on this, a motion trajectory of the reference portrait may be planned continuously.

In this way, a motion process from static to slight shake and then to static when a human body is in a silent state is simulated by using a change rate of the trigonometric function, so that the motion of the portrait looks more natural.

During another specific implementation, the reference portrait in the original image may specifically be identified, and then a plurality of sampling points may be acquired from the original image based on the reference portrait, to divide the original image into a plurality of triangles. Then, at least part of the triangles in the original image may be deformed based on the at least one change parameter, to obtain the at least one change image.

In patches of a polygonal mesh, a triangular patch is a minimum unit to be divided, with simple and flexible representation and convenient topological description. Therefore, by dividing the original image into a plurality of triangles, the original image can be divided into the minimum unit for change processing of the portrait posture.

During the implementation, the plurality of sampling points may be acquired from the original image based on the reference portrait in a preset point sampling manner. The plurality of sampling points may include sampling points inside the reference portrait and sampling points outside the reference portrait. After the plurality of sampling points are acquired, the original image may be divided into a plurality of triangles based on the plurality of sampling points by using a triangulation algorithm, or the original image may be divided into a plurality of triangles by using other algorithms, which are not listed herein.

Three vertices of each triangle are all sampling points. During the implementation, at least part of the triangles in the original image may be deformed by changing a position of at least one sampling point. In this way, the original image after the at least part of the triangles are deformed may be defined as the change image. It may be understood that, since at least part of the triangles in the change image are different from the corresponding triangles in the original image, a portrait posture in the change image is different from that in the original image.

As described above, in this embodiment, a plurality of sampling points are required to be acquired from the original image based on the reference portrait. Part of the sampling points may have same characteristics. Therefore, during the implementation, a sampling range of each type of sampling points with the same characteristics may be pre-determined, and then each type of sampling points may be acquired within the determined sampling range of each type of sampling points.

The corresponding sampling range of each type of sampling points may be determined within a position range in the original image based on the reference portrait. When the sampling points are acquired within the sampling range of each type of sampling points, any sampling point should not on a portrait contour of the reference portrait. Specifically, as shown in FIG. 3, the portrait contour of the reference portrait is an interface between the black region and the white region in FIG. 3, and no sampling point is on this interface.

During the implementation, positions and numbers of the sampling points acquired within the sampling range of each type of sampling points may be determined according to an actual design requirement. An exemplary process of acquiring the sampling points may be further introduced in the subsequent content in the present disclosure.

For example, the sampling points may include, but are not limited to, contour edge points and portrait interior points, which is not particularly limited in this embodiment. Specifically, morphological processing may be performed based on the reference portrait to obtain a morphological contour. The morphological contour includes a portrait dilation contour and a portrait erosion contour. Then, a plurality of sampling points may be acquired from the morphological contour as the contour edge points, and a plurality of sampling points may be acquired inside the portrait erosion contour as the portrait interior points.

Specifically, the reference portrait may specifically be dilated and eroded respectively, so as to determine the portrait dilation contour and the portrait erosion contour. Dilating the reference portrait may mean scaling up the reference portrait so that the resulting portrait dilation contour can include the reference portrait. Eroding the reference portrait may mean scaling down the reference portrait so that the resulting portrait erosion contour can be completely included inside the reference portrait.

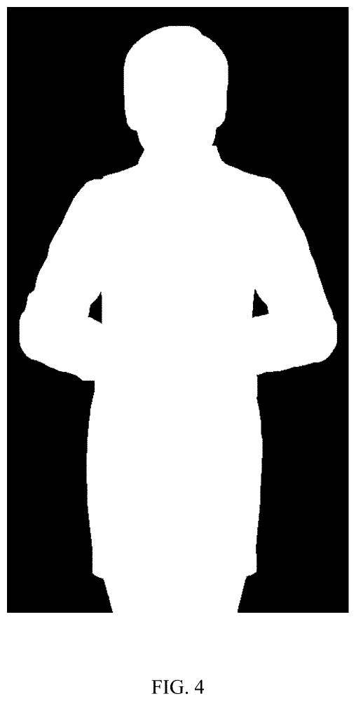

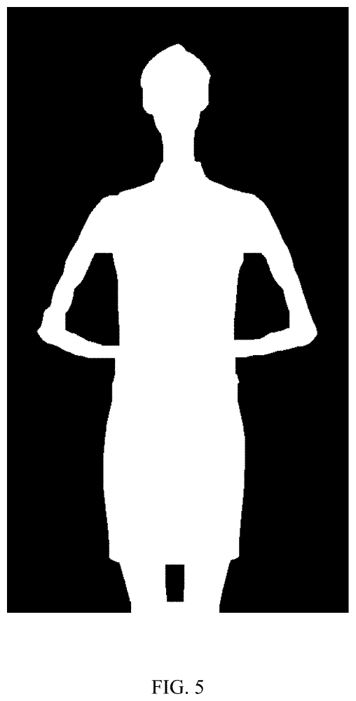

FIG. 4 is a schematic diagram of a portrait dilation contour determined from the original image provided in FIG. 2. FIG. 5 is a schematic diagram of a portrait erosion contour determined from the original image provided in FIG. 2. In FIG. 4, the black region represents background content, and the interface between the black region and the white region represents the portrait dilation contour. In FIG. 5, the black region represents background content, and the interface between the black region and the white region represents the portrait erosion contour.

It may be understood that the portrait dilation contour in FIG. 4 is obtained after the reference portrait in FIG. 3 is dilated, and the portrait dilation contour may include the reference portrait; the portrait erosion contour in FIG. 5 is obtained after the reference portrait in FIG. 3 is eroded, and the portrait erosion contour may be completely included inside the reference portrait.

Since the portrait dilation contour may include the reference portrait and the portrait erosion contour may be completely included inside the reference portrait, sampling points on the portrait dilation contour are all outside the reference portrait, sampling points on the portrait erosion contour are all inside the reference portrait, and sampling points inside the reference portrait are also on an inner side of the portrait contour of the reference portrait. That is, no sampling points exist on the portrait contour of the reference portrait.

Alternatively, further, in another example, the sampling points may further include change control points in addition to the contour edge points and the portrait interior points. Correspondingly, a plurality of sampling points outside the portrait dilation contour may be further acquired as the change control points. The contour edge points and the portrait interior points may be collectively called portrait sampling points, and the change control points may be called background sampling points.

During the implementation, the portrait dilation contour may be taken as a sampling range of the portrait sampling points. Therefore, in addition to acquiring the portrait sampling points, namely the contour edge points and the portrait interior points, within the sampling range of the portrait sampling points, a plurality of background sampling points, namely change control points, may be further obtained outside the sampling range of the portrait sampling points (i.e., outside the portrait dilation contour). That is, no sampling points exist on the portrait contour of the reference portrait. When the original image is divided into a plurality of triangles through the sampling points, vertices of the triangle outside the portrait dilation contour are a combination of change control points and portrait sampling points. For example, the three vertices of the triangle may be one change control point and two portrait sampling points or two change control point and one portrait sampling point.

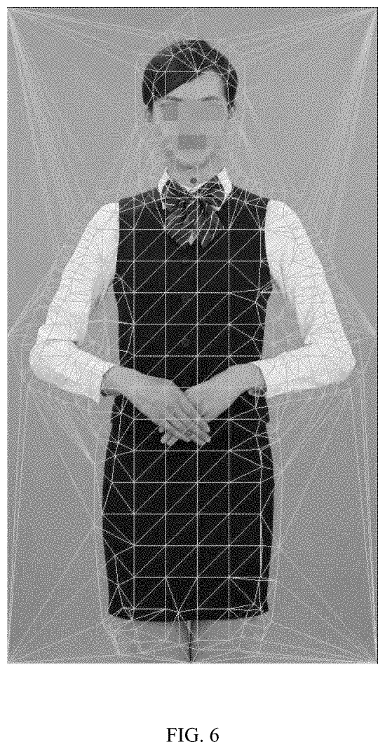

In order to further reduce a degree of deformation of the triangle in a region where the background part is located, a plurality of change control points may be acquired from a boundary of the original image. It may be understood that the triangle whose vertices are the change control points on the boundary of the original image is located in a region where the background content is located and has a large area. FIG. 6 is a schematic diagram of exemplary distribution of triangles into which the original image provided in FIG. 2 is divided. In FIG. 6, a circle of sampling points on the outer side of the reference portrait are contour edge points on the portrait dilation contour, 8 sampling points on the boundary of the original image are change control points, and the triangle whose vertices are the change control points on the boundary of the original image is located in a background region. When the position of each contour edge point changes to a same degree, the degree of deformation of the triangle located in the region of the background content is less than that of the triangle inside the reference portrait, so as to avoid large deformation in the region of the background content in the change image and ensure a visual effect of the image.

During the implementation, the original image is divided into a plurality of triangles based on a plurality of sampling points by using a triangulation algorithm. For example, designated change control points, and designated contour edge points and/or portrait interior points (for example, two change control points and one contour edge point, or one change control point, one contour edge point and one portrait interior point, or one change control point and two contour edge points, or one change control point and two portrait interior points) may be taken as the vertices of the triangle, or designated contour edge points and designated portrait interior points (for example, two contour edge points and one portrait interior point, or one contour edge point and two portrait interior points) may be taken as the vertices of the triangle. Certainly, in this embodiment, the original image may also be divided into a plurality of triangles by using other algorithms, which are not listed herein.

During another specific implementation, the change parameter may include, but is not limited to, a rotation angle. Specifically, human body key points of preset types may be identified according to the reference portrait in the original image, and then the sampling points in the at least part of the triangles in the original image may be rotated by the rotation angle indicated by the change parameter based on at least one type of human body key points, to obtain the at least one change image.

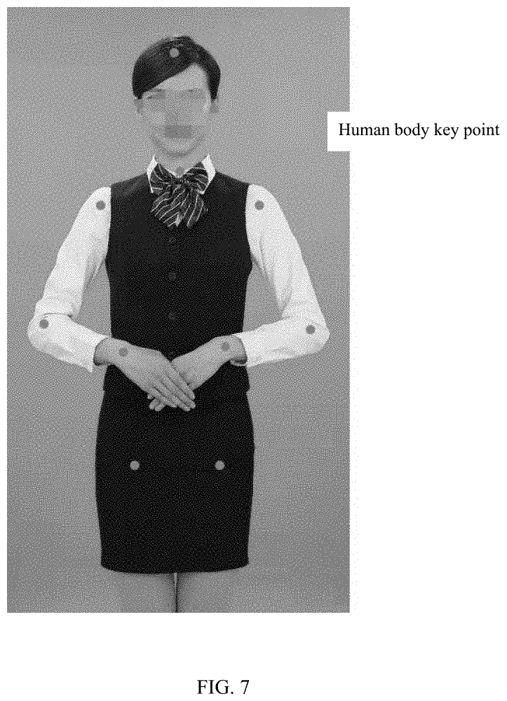

During the implementation, a plurality of types of human body key points may be predefined, such as an ankle key point, a waist key point and a neck key point. FIG. 7 is a schematic diagram of exemplary distribution of one type of human body key points the original image provided in FIG. 2 is divided. In FIG. 7, each dot represents one type of human body key points.

During the implementation, at least one type of human body key points may be selected from the human body key points shown in FIG. 7 as the human body key points of preset types. For example, the ankle key point, the waist key point and the neck key point may be defined as the human body key points of preset types.

During the implementation, human body key points of preset types may be identified from the reference portrait in the original image, and then at least one sampling point may be rotated by the rotation angle indicated by the change parameter based on at least one type of human body key points, so as to deform at least part of the triangles in the original image.

Specifically, the human body key points of preset types identified from the reference portrait in the original image are taken as rotation center points, and the at least one sampling point is rotated by the rotation angle indicated by the change parameter based on the rotation center points, so that at least part of the triangles are deformed by changing a position of the at least one sampling point and the original image after the at least part of the triangles are deformed is defined as the change image.

It may be understood that, since at least part of the triangles in the change image are different from the corresponding triangles in the original image, a portrait posture in the change image is different from that in the original image.

The human body key points of preset types identified from the reference portrait in the original image may be taken as rotation center points of at least one sampling point. To-be-rotated sampling points may be determined according to an actual design requirement. A rotation angle by which the sampling points are required to be rotated depends on the change parameter obtained based on the nonlinear function.

In this embodiment, in order to prevent large deformation in the region where the background content in the change image is located, only a position of at least one of the portrait sampling points (i.e., the contour edge points and the portrait interior points) may be changed. Specifically, at least one portrait sampling point may be rotated by the rotation angle indicated by the change parameter based on at least one type of human body key points. In this way, deformation of the triangle in the region where the background content is located may be prevented as much as possible, so as to prevent large deformation of the background content in the change image and ensure the visual effect of the image.

For example, the ankle key point (not shown), the waist key point and the neck key point are the human body key points of preset types. Firstly, the ankle key point is taken as a rotation center, and all portrait sampling points above the ankle key point are rotated by the rotation angle indicated by the change parameter. Then, the waist key point is taken as a rotation center, and all portrait sampling points above the waist key point are further rotated by the rotation angle indicated by the change parameter. Finally, the neck key point is taken as a rotation center, and all portrait sampling points above the neck key point are further rotated by the rotation angle indicated by the change parameter, so that a series of change images may be obtained eventually.

Optionally, in one possible implementation of this embodiment, a step of adjusting parameters of the nonlinear function may be further included.

Specifically, the parameters of the nonlinear function may specifically be adjusted according to a real physiological state of a human body.

For example, a motion rate of the reference portrait may be adjusted by adjusting a parameter n (inversely proportional to a frequency of the trigonometric function) in each round of the motion of the reference portrait.

Alternatively, in other example, motion amplitude of the reference portrait may also be adjusted by adjusting amplitude of the trigonometric function (theta or theta′).

In this way, the parameters of the nonlinear function adjusted based on the real physiological state of the human body, such as a change parameter number (n) outputted by the trigonometric function and the amplitude of the trigonometric function, have randomness within a certain numerical range, so as to prevent simple “pendulum”-like shaking of the motion of the human body.

At the same time, at the end of a motion, random natural action may be further introduced, such as pauses, which can further enhance the sense of reality of the motion trajectory and make the motion of the virtual portrait look more natural.

In this embodiment, a reference portrait in an original image is determined, and then posture change processing is performed on the reference portrait in the original image by using a nonlinear function, to obtain at least one change image, so that a dynamic video of the reference portrait can be generated according to the original image and the at least one change image, which does not require manual participation, and is easy to operate and error-free, thereby improving the efficiency and reliability of dynamic video generation.

In addition, user experience can be effectively improved by using the technical solutions according to the present disclosure.

It is to be noted that, to make the description brief, the foregoing method embodiments are expressed as a series of actions. However, those skilled in the art should appreciate that the present disclosure is not limited to the described action sequence, because according to the present disclosure, some steps may be performed in other sequences or performed simultaneously. In addition, those skilled in the art should also appreciate that all the embodiments described in the specification are preferred embodiments, and the related actions and modules are not necessarily mandatory to the present disclosure.

In the above embodiments, the descriptions of the embodiments have respective focuses. For a part that is not described in detail in one embodiment, refer to related descriptions in other embodiments.

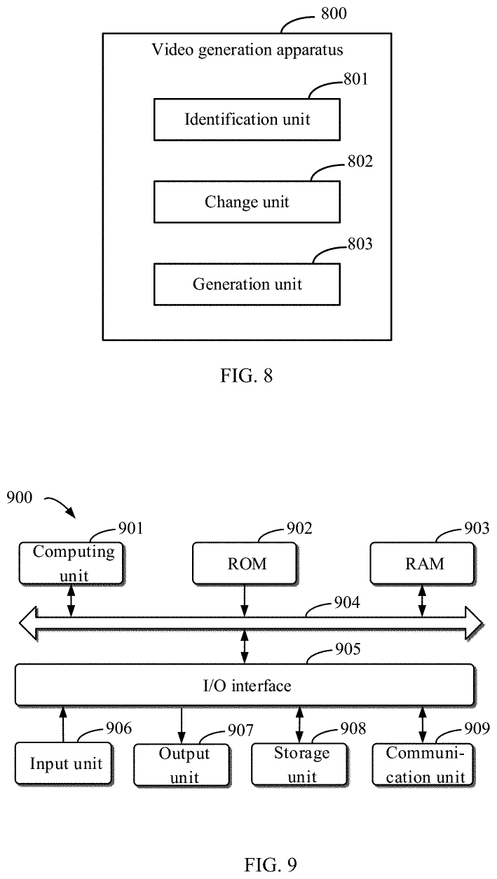

FIG. 8 is a schematic diagram according to a second embodiment of the present disclosure, as shown in FIG. 8. A video generation apparatus 800 according to this embodiment may include an identification unit 801, a change unit 802 and a generation unit 803. The identification unit 801 is configured to determine a reference portrait in an original image. The change unit 802 is configured to perform posture change processing on the reference portrait in the original image by using a nonlinear function, to obtain at least one change image. The generation unit 803 is configured to generate a dynamic video of the reference portrait according to the original image and the at least one change image.

It is to be noted that part or all of the video generation apparatus according to this embodiment may be an APP located at a local terminal, or a functional unit such as a plug-in or SDK provided in an App located at a local terminal, or a processing engine located in a network-side server, or a distributed system on a network side, for example, a processing engine or distributed system in an image processing platform on a network side or the like, which is not particularly limited in this embodiment.

It may be understood that the APP may be a native application (nativeApp) installed in the local terminal, or a web application (webApp) of a browser in the local terminal, which is not particularly limited in this embodiment.

Optionally, in one possible implementation of this embodiment, the identification unit 801 may specifically be configured to take an image including the reference portrait as the original image; or obtain a continuous multi-frame image including the reference portrait from a video as the original image.

Optionally, in one possible implementation of this embodiment, the change unit 802 may specifically be configured to obtain at least one change parameter of the reference portrait by using the nonlinear function; and perform posture change processing on the reference portrait in the original image based on the at least one change parameter, to obtain the at least one change image.

During one specific implementation, the change unit 802 may specifically be configured to identify the reference portrait in the original image; acquire a plurality of sampling points from the original image based on the reference portrait, to divide the original image into a plurality of triangles; and deform at least part of the triangles in the original image based on the at least one change parameter, to obtain the at least one change image.

Specifically, the sampling points may include, but are not limited to, contour edge points and portrait interior points, which is not particularly limited in this embodiment. Correspondingly, the change unit 802 may specifically be configured to perform morphological processing based on the reference portrait to obtain a morphological contour; wherein the morphological contour includes a portrait dilation contour and a portrait erosion contour; acquire a plurality of sampling points from the morphological contour as the contour edge points; and acquire a plurality of sampling points inside the portrait erosion contour as the portrait interior points.

Further, the sampling points may further include change control points; correspondingly, the change unit 802 may specifically be configured to acquire a plurality of sampling points outside the portrait dilation contour as the change control points.

During another specific implementation, the change parameter may include, but is not limited to, a rotation angle, which is not particularly limited in this embodiment. Correspondingly, the change unit 802 may specifically be configured to identify human body key points of preset types according to the reference portrait in the original image; and rotate the sampling points in the at least part of the triangles in the original image by the rotation angle indicated by the change parameter based on at least one type of human body key points, to obtain the at least one change image.

Optionally, in one possible implementation of this embodiment, the change unit 802 may be further configured to adjust parameters of the nonlinear function according to a real physiological state of a human body.

In this embodiment, the identification unit determines a reference portrait in an original image, and then the change unit performs posture change processing on the reference portrait in the original image by using a nonlinear function, to obtain at least one change image, so that the generation unit can generate a dynamic video of the reference portrait according to the original image and the at least one change image, which does not require manual participation, and is easy to operate and error-free, thereby improving the efficiency and reliability of dynamic video generation.

In addition, user experience can be effectively improved by using the technical solutions according to the present disclosure.

Acquisition, storage and application of users' personal information involved in the technical solutions of the present disclosure, such as users' physiological parameters and users' identity information, comply with relevant laws and regulations, and do not violate public order and moral.

According to embodiments of the present disclosure, the present disclosure further provides an electronic device, a readable storage medium and a computer program product.

FIG. 9 is a schematic block diagram of an exemplary electronic device 900 configured to implement embodiments of the present disclosure. The electronic device is intended to represent various forms of digital computers, such as laptops, desktops, workbenches, servers, blade servers, mainframe computers and other suitable computing devices. The electronic device may further represent various forms of mobile devices, such as PDAs, cellular phones, smart phones, wearable devices and other similar computing devices. The components, their connections and relationships, and their functions shown herein are examples only, and are not intended to limit the implementation of the present disclosure as described and/or required herein.

As shown in FIG. 9, the electronic device 900 includes a computing unit 901, which may perform various suitable actions and processing according to a computer program stored in a read-only memory (ROM) 902 or a computer program loaded from a storage unit 908 into a random access memory (RAM) 903. The RAM 903 may also store various programs and data required to operate the electronic device 900. The computing unit 901, the ROM 902 and the RAM 903 are connected to one another by a bus 904. An input/output (I/O) interface 905 is also connected to the bus 904.

A plurality of components in the electronic device 900 are connected to the I/O interface 905, including an input unit 906, such as a keyboard and a mouse; an output unit 907, such as various displays and speakers; a storage unit 908, such as disks and discs; and a communication unit 909, such as a network card, a modem and a wireless communication transceiver. The communication unit 909 allows the electronic device 900 to exchange information/data with other devices over computer networks such as the Internet and/or various telecommunications networks.

The computing unit 901 may be a variety of general-purpose and/or special-purpose processing components with processing and computing capabilities. Some examples of the computing unit 901 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 901 performs the methods and processing described above, such as the video generation method. For example, in some embodiments, the video generation method may be implemented as a computer software program that is tangibly embodied in a machine-readable medium, such as the storage unit 908. In some embodiments, part or all of a computer program may be loaded and/or installed on the electronic device 900 via the ROM 902 and/or the communication unit 909. One or more steps of the video generation method described above may be performed when the computer program is loaded into the RAM 903 and executed by the computing unit 901. Alternatively, in other embodiments, the computing unit 901 may be configured to perform the video generation method by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable video generation apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), the Internet and a blockchain network.

The computer system may include a client and a server. The client and the server are generally far away from each other and generally interact via the communication network. A relationship between the client and the server is generated through computer programs that run on a corresponding computer and have a client-server relationship with each other. The server may be a cloud server, also known as a cloud computing server or cloud host, which is a host product in the cloud computing service system to solve the problems of difficult management and weak business scalability in the traditional physical host and a Virtual Private Server (VPS). The server may also be a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the protection scope of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the protection scope of the present disclosure.

What is claimed is:

1. A video generation method, comprising:
determining a reference portrait in an original image;
performing posture change processing on the reference portrait in the original image by using a nonlinear function, to obtain at least one change image; and
generating a dynamic video of the reference portrait according to the original image and the at least one change image.

2. The method according to claim 1, wherein the step of determining a reference portrait in an original image comprises:
taking an image comprising the reference portrait as the original image; or
obtaining a continuous multi-frame image comprising the reference portrait from a video as the original image.

3. The method according to claim 1, wherein the step of performing posture change processing on the reference portrait in the original image by using a nonlinear function, to obtain at least one change image comprises:
obtaining at least one change parameter of the reference portrait by using the nonlinear function; and
performing posture change processing on the reference portrait in the original image based on the at least one change parameter, to obtain the at least one change image.

4. The method according to claim 3, wherein the step of performing posture change processing on the reference portrait in the original image based on the at least one change parameter, to obtain the at least one change image comprises:
identifying the reference portrait in the original image;
acquiring a plurality of sampling points from the original image based on the reference portrait, to divide the original image into a plurality of triangles; and
deforming at least part of the triangles in the original image based on the at least one change parameter, to obtain the at least one change image.

5. The method according to claim 4, wherein the sampling points comprise contour edge points and portrait interior points; and the step of acquiring a plurality of sampling points from the original image based on the reference portrait comprises:
performing morphological processing based on the reference portrait to obtain a morphological contour; wherein the morphological contour comprises a portrait dilation contour and a portrait erosion contour;
acquiring a plurality of sampling points from the morphological contour as the contour edge points; and
acquiring a plurality of sampling points inside the portrait erosion contour as the portrait interior points.

6. The method according to claim 5, wherein the sampling points further comprise change control points; and the step of acquiring a plurality of sampling points from the original image based on the reference portrait, to divide the original image into a plurality of triangles comprises:
acquiring a plurality of sampling points outside the portrait dilation contour as the change control points.

7. The method according to claim 4, wherein the change parameter comprises a rotation angle; and the step of deforming at least part of the triangles in the original image based on the at least one change parameter, to obtain the at least one change image comprises:
identifying human body key points of preset types according to the reference portrait in the original image; and
rotating the sampling points in the at least part of the triangles in the original image by the rotation angle indicated by the change parameter based on at least one type of human body key points, to obtain the at least one change image.

8. The method according to claim 5, wherein the change parameter comprises a rotation angle; and the step of deforming at least part of the triangles in the original image based on the at least one change parameter, to obtain the at least one change image comprises:
identifying human body key points of preset types according to the reference portrait in the original image; and
rotating the sampling points in the at least part of the triangles in the original image by the rotation angle indicated by the change parameter based on at least one type of human body key points, to obtain the at least one change image.

9. The method according to claim 6, wherein the change parameter comprises a rotation angle; and the step of deforming at least part of the triangles in the original image based on the at least one change parameter, to obtain the at least one change image comprises:
identifying human body key points of preset types according to the reference portrait in the original image; and
rotating the sampling points in the at least part of the triangles in the original image by the rotation angle indicated by the change parameter based on at least one type of human body key points, to obtain the at least one change image.

10. The method according to claim 1, wherein the method further comprises:
adjusting parameters of the nonlinear function according to a real physiological state of a human body.

11. An electronic device, comprising:
at least one processor; and
a memory communicatively connected with the at least one processor;
wherein the memory stores instructions executable by the at least one processor, and the instructions are executed by the at least one processor to enable the at least one processor to perform a video generation method, wherein the video generation method comprises:
determining a reference portrait in an original image;
performing posture change processing on the reference portrait in the original image by using a nonlinear function, to obtain at least one change image; and
generating a dynamic video of the reference portrait according to the original image and the at least one change image.

12. The electronic device according to claim 11, wherein the step of determining a reference portrait in an original image comprises:
taking an image comprising the reference portrait as the original image; or
obtaining a continuous multi-frame image comprising the reference portrait from a video as the original image.

13. The electronic device according to claim 11, wherein the step of performing posture change processing on the reference portrait in the original image by using a nonlinear function, to obtain at least one change image comprises:
obtaining at least one change parameter of the reference portrait by using the nonlinear function; and
performing posture change processing on the reference portrait in the original image based on the at least one change parameter, to obtain the at least one change image.

14. The electronic device according to claim 13, wherein the step of performing posture change processing on the reference portrait in the original image based on the at least one change parameter, to obtain the at least one change image comprises:
identifying the reference portrait in the original image;
acquiring a plurality of sampling points from the original image based on the reference portrait, to divide the original image into a plurality of triangles; and
deforming at least part of the triangles in the original image based on the at least one change parameter, to obtain the at least one change image.

15. The electronic device according to claim 14, wherein the sampling points comprise contour edge points and portrait interior points; and the step of acquiring a plurality of sampling points from the original image based on the reference portrait comprises:
performing morphological processing based on the reference portrait to obtain a morphological contour; wherein the morphological contour comprises a portrait dilation contour and a portrait erosion contour;
acquiring a plurality of sampling points from the morphological contour as the contour edge points; and
acquiring a plurality of sampling points inside the portrait erosion contour as the portrait interior points.

16. The electronic device according to claim 15, wherein the sampling points further comprise change control points; and the step of acquiring a plurality of sampling points from the original image based on the reference portrait, to divide the original image into a plurality of triangles comprises:
acquiring a plurality of sampling points outside the portrait dilation contour as the change control points.

17. The electronic device according to claim 14, wherein the change parameter comprises a rotation angle; and the step of deforming at least part of the triangles in the original image based on the at least one change parameter, to obtain the at least one change image comprises:
identifying human body key points of preset types according to the reference portrait in the original image; and
rotating the sampling points in the at least part of the triangles in the original image by the rotation angle indicated by the change parameter based on at least one type of human body key points, to obtain the at least one change image.

18. The electronic device according to claim 15, wherein the change parameter comprises a rotation angle; and the step of deforming at least part of the triangles in the original image based on the at least one change parameter, to obtain the at least one change image comprises:
identifying human body key points of preset types according to the reference portrait in the original image; and
rotating the sampling points in the at least part of the triangles in the original image by the rotation angle indicated by the change parameter based on at least one type of human body key points, to obtain the at least one change image.

19. The electronic device according to claim 11, wherein the method further comprises:
adjusting parameters of the nonlinear function according to a real physiological state of a human body.

20. A non-transitory computer readable storage medium with computer instructions stored thereon, wherein the computer instructions are used for causing a computer to perform a video generation method, wherein the video generation method comprises:
determining a reference portrait in an original image;
performing posture change processing on the reference portrait in the original image by using a nonlinear function, to obtain at least one change image; and
generating a dynamic video of the reference portrait according to the original image and the at least one change image.
